(19) United States
(12) Patent Application Publication
(10) Pub. No.: US 2025/0289130 A1
(43) Pub. Date: Sep. 18, 2025

(54) MOTION CONTROL SYSTEM OF ROBOT AND ROBOT

(71) Applicant: Beijing Youzhuju Network Technology Co., Ltd., Beijing (CN)

(72) Inventors: Jiafeng Xu, Beijing (CN); Guangzeng Chen, Beijing (CN); Tao Kong, Beijing (CN)

(21) Appl. No.: 19/034,514

(22) Filed: Jan. 22, 2025

(30) Foreign Application Priority Data
Mar. 18, 2024 (CN) 202410311277.X

(51) Int. Cl. B25J 9/16; B25J 13/08; B62D 57/028

(52) U.S. Cl. CPC B25J 9/1664; B25J 13/089; B62D 57/028

(57) ABSTRACT

The disclosure provides a motion control system of a robot and a robot, wherein the robot is a wheel-foot composite robot which comprises a robot body and a motion mechanism arranged on the robot body; the motion mechanism comprises two rear rollers and two front leg mechanisms; the system comprises a motion planning module configured to determine a first, second and third motion tasks based on the target task and the latest actual state information of the wheel-foot composite robot; the motion control module config to control the whole body motion of the wheel-foot composite robot based on the first, second and third motion tasks; the state perception module configured to determine actual state information of the wheel-foot composite robot, and sending the actual state information to the motion planning module, so that the motion planning module performs new motion planning based on the actual state information.

### CROSS-REFERENCE

This application claims the benefit of Chinese Patent Application No. 202410311277.X entitled “MOTION CONTROL SYSTEM OF ROBOT AND ROBOT” filed on Mar. 18, 2024, the entire content of which is incorporated herein by reference.

### FIELD

Embodiments of the invention relate to the technical field of robots, in particular to a motion control system of a robot and a robot.

### BACKGROUND

With the development of robot technology, robots are gradually applied in various fields, for example, in industrial and agricultural production, social services, and household services, thereby assisting or even replacing humans in completing heavy and complex tasks, thus improving work efficiency and quality. In practical applications, when robots execute tasks, they may experience poor task execution performance due to reasons such as imprecise motion control or errors. Therefore, how to precisely control robot motion has become an urgent problem that needs to be solved at present.

### SUMMARY

Embodiments of the present disclosure provide a motion control system of a robot and a robot, which can accurately perform closed-loop control on the motion of a robot to ensure that the robot can efficiently, stably and accurately perform a task, thereby improving the robot's task execution effect and improving the user experience.

In a first aspect, an embodiment of the present disclosure provides a motion control system of a robot, where the robot is a wheel-foot composite robot, the wheel-foot composite robot includes a robot body and four motion mechanisms arranged on the robot body, the four motion mechanisms include two rear rollers and two front leg mechanisms, and the system includes a motion planning module, a motion control module, and a state perception module.

The motion planning module is configured to determine a first motion task of the robot body, a second motion task of the two front leg mechanisms, and a third motion task of the two rear rollers based on a target task and latest actual state information of the wheel-foot composite robot.

The motion control module is configured to control whole-body motion of the wheel-foot composite robot based on the first motion task, the second motion task, and the third motion task sent by the motion planning module.

The state perception module is configured to determine actual state information of the wheel-foot composite robot, and send the actual state information of the wheel-foot composite robot to the motion planning module, so that the motion planning module performs new motion planning based on the actual state information of the wheel-foot composite robot.

In a second aspect, an embodiment of the present disclosure provides a robot including a motion control system of a robot according to the first aspect.

### BRIEF DESCRIPTION OF DRAWINGS

In order to more clearly illustrate the technical solutions in embodiments of the present disclosure, the accompanying drawings that need to be used in the description of embodiments are briefly described below, and obviously, the drawings in the following description are merely some embodiments of the present disclosure, and for those of ordinary skill in the art, other drawings may be obtained based on these drawings without creative work.

FIG. 1 is a schematic structural diagram of a wheel-foot composite robot according to an embodiment of the present disclosure;

FIG. 2 is an example block diagram of a robot motion control system according to an embodiment of the present disclosure;

FIG. 3 is a schematic diagram of a center point of rear rollers according to an embodiment of the present disclosure;

FIG. 4 is a schematic block diagram of another robot motion control system according to an embodiment of the present disclosure;

FIG. 5 is a schematic block diagram of yet another robot motion control system according to an embodiment of the present disclosure;

FIG. 6 is a schematic block diagram of still another robot motion control system according to an embodiment of the present disclosure;

FIG. 7 is a schematic block diagram of a robot according to an embodiment of the present disclosure.

### DETAILED DESCRIPTION

The technical solutions in embodiments of the present disclosure are clearly and completely described below with reference to the accompanying drawings in embodiments of the present disclosure. All other embodiments obtained by those skilled in the art without creative efforts shall fall within the scope of the present disclosure.

It should be noted that the terms “first”, “second”, and the like in the specification and claims of the present disclosure and the foregoing drawings are used to distinguish similar objects, and are not necessarily used to describe a specific order or sequence. It should be understood that such used data may be interchanged where appropriate so that embodiments of the present disclosure described herein can be implemented in an order other than those illustrated or described herein. Moreover, the terms “comprising” and “having” and any variations thereof are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In embodiments of the present disclosure, words such as “example” or “for example” are used to indicate examples, illustrations, or descriptions, and any embodiment or solution described as “example” or “for example” in embodiments of the present disclosure should not be construed as being more preferred or advantageous than other embodiments or solutions. Rather, words such as “example” or “for example” are intended to present related concepts in a specific manner.

In the description of embodiments of the present disclosure, it should also be noted that, unless specified and defined otherwise, the terms “set”, “disposed”, “coupled”, and “connected” should be understood in a broad sense. For example, they can refer to fixed connection, detachable connection, or integral connection; mechanical connection or electrical connection; direct connection or indirect connection through intermediate media, or internal communication between two elements or interaction relationship between two elements. For those skilled in the art, the specific meaning of the above terms in the present disclosure can be understood in combination with the prior art according to specific conditions. In addition, in the absence of conflicts, the features in embodiments of the present disclosure may be combined with each other. Additionally, one or more of the components in the illustration may be necessary or not required, and the relative positional relationship between the various components illustrated above may be adjusted as desired.

In the description of embodiments of the present disclosure, unless otherwise specified, “a plurality of” refer to two or more, that is, at least two. “At least one” means one or more.

Since robots may experience poor task execution performance due to reasons such as imprecise motion control or errors when executing tasks, the inventive concept of the present disclosure addressing this technical problem is: through the motion planning module, based on the target task to be executed by the wheel-foot composite robot and its latest actual state information, determining the first motion task for the robot body, the second motion task for the lifted leg mechanism of the two front leg mechanisms, and the third motion task for the center point of the two rear rollers, and sending these tasks to the motion control module, enabling the motion control module to control the whole-body motion of the wheel-foot composite robot based on these tasks. Furthermore, through the state perception module determining the actual state information of the wheel-foot composite robot and send the actual state information of the wheel-foot composite robot to the motion planning module, so that the motion planning module can perform new motion planning based on this information, thereby achieving precise closed-loop control of robot motion to ensure efficient, stable, and precise task execution, improving robot task performance and user experience.

The technical solutions of the present disclosure are described in detail below with some embodiments. Embodiments described below may be combined with each other, and may not be repeated for the same or similar concepts or processes.

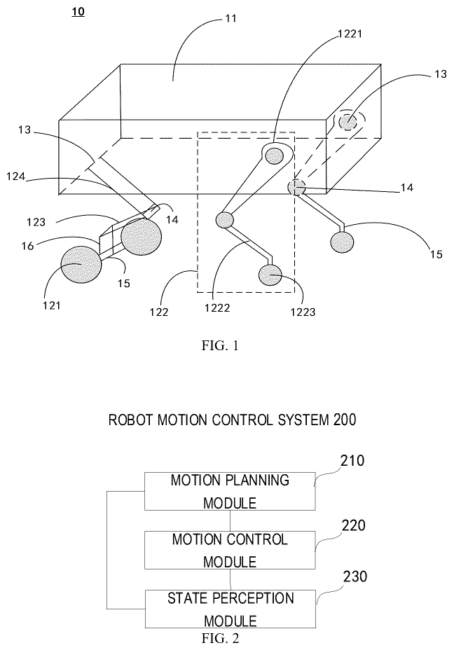

First, a structure of a wheel-foot composite robot in an embodiment of the present disclosure is specifically described. As shown in FIG. 1, the wheel-foot composite robot 10 includes a robot body 11 and four motion mechanisms disposed on the robot body 11, wherein the four motion mechanisms include two rear rollers 121 and two front leg mechanisms 122.

In the present disclosure, the two front leg mechanisms 122 include a left front leg mechanism and a right front leg mechanism. Each of the front leg mechanisms 122 includes a front thigh mechanism 1221, a front shank mechanism 1222, and a roller 1223 disposed at an end of each front shank mechanism. The roller 1223 on the end of the front shank mechanism may be understood as an roller. The connecting part of the front thigh mechanism 1221 and the robot body 11 in FIG. 1 is a hip joint 13, the connecting part of the front thigh mechanism 1221 and the front shank mechanism 1222 is a knee joint 14, and the connecting part of the front shank mechanism 1222 and the roller 1223 is an ankle joint 15.

In some optional embodiments, the two rear rollers 121 are disposed at two ends of the rotatable connecting member 16, the rotatable end of the connecting member 16 is connected to one end of the rear shank mechanism 123, the other end of the rear shank mechanism 123 is connected to one end of the rear thigh mechanism 124, and the other end of the rear thigh mechanism 124 is connected to the robot body 11. The two rear rollers 121 may be understood as driving wheels.

That is, the motion mechanisms disposed on the robot body 11 in the present disclosure include a rear leg mechanism, wherein the rear leg mechanism includes a rear thigh mechanism 124, a rear shank mechanism 123, a connecting member 16, and two rear rollers 121 disposed at two ends of the connecting member 16. In the present disclosure, the connecting part of the rear thigh mechanism 124 and the robot body 11 is the hip joint 13, the connecting part of the rear thigh mechanism 124 and the rear shank mechanism 123 is the knee joint 14, the connecting part of the rear shank mechanism 124 and each rear roller 121 is the ankle joint 15. That is, the leg mechanism of the present disclosure includes a hip joint 13, a knee joint 14, and two ankle joints 15.

In addition, the hip joint 13, the knee joint 14, and the ankle joints 15 are correspondingly provided with motors, specifically, a hip joint motor, a knee joint motor and ankle joint motors, so that corresponding torques are output through the hip joint motor, the knee joint motor and/or the ankle joint motors, and the change of the hip joint 13, the knee joint 14 and/or the ankle joint 15 is driven to switch the motion mode of the wheel-foot composite robot.

The above joints may be understood as indicating that at least two components of the wheel-foot composite robot are movably connected. Moreover, each joint can move under the control of torque output by the joint motor. For example, a certain joint can rotate an angle, so that other joints and related mechanisms generate a certain amount of motion in the space, thereby realizing the motion mode change operation of the wheel-foot composite robot.

Further, in order to detect whether there is an obstacle in different motion environments and in a motion environment, at least one environment perception sensor may be disposed at the front end of the robot body 11 of the wheel-foot composite robot 10, and at least one environment perception sensor may be disposed at the rear end of the robot body 11, so that the wheel-foot composite robot may implement functions such as autonomous obstacle avoidance and mapping navigation based on the environment perception sensor.

The environment perception sensor may include, but is not limited to, a laser sensor, a vision sensor, an infrared sensor, an ultrasonic sensor, and a laser radar sensor.

As an optional implementation, a visual sensor may be disposed at a middle position of the front end of the robot body 11 shown in FIG. 1, a laser radar sensor is respectively disposed on the left and right sides of the middle of the robot body 11, a laser sensor is disposed at a middle position of the rear end of the robot body 11, and an ultrasonic sensor (not shown) is respectively disposed on the left and right sides of the middle of the robot body 11.

It should be noted that the number, the position, and the type of the environment perception sensors disposed on the robot body 11 in the present disclosure are merely illustrative, and may be flexibly adjusted based on actual application requirements, which is not limited in the present disclosure.

After the structure of the wheel-foot composite robot is described, the robot motion control system and the robot provided in embodiments of the present disclosure are specifically described below. The robot is the wheel-foot composite robot described above.

FIG. 2 is an example block diagram of a robot motion control system according to an embodiment of the present disclosure. As shown in FIG. 2, the robot motion control system 200 includes a motion planning module 210, a motion control module 220, and a state perception module 230.

The motion planning module 210 is configured to determine a first motion task of the robot body, a second motion task of the two front leg mechanisms, and a third motion task of the two rear rollers based on the latest actual state information of the target task and the wheel-foot composite robot.

The motion control module 220 is configured to control the whole-body motion of the wheel-foot composite robot based on the first motion task, the second motion task, and the third motion task sent by the motion planning module.

The state perception module 230 is configured to determine actual state information of the wheel-foot composite robot, and send the actual state information of the wheel-foot composite robot to the motion planning module, so that the motion planning module 210 performs new motion planning based on the actual state information of the wheel-foot composite robot.

It should be understood that the motion planning module 210 of the present disclosure performs new motion planning based on the actual state information of the wheel-foot composite robot, which means that the motion planning module 210 determines the first motion task of the robot body, the second motion task of the two front leg mechanisms, and the third motion task of the two rear rollers based on the latest actual state information of the wheel-foot composite robot during the next planning cycle.

The planning cycle of the motion planning module 210 may be comprehensively determined based on factors such as a motion planning requirement, a hardware computing power, and an algorithm complexity of the wheel-foot composite robot. In some optional implementations, if the real-time requirement for the motion planning of the wheel-foot composite robot is high, the hardware computing power is high, etc., the planning cycle may be set to a small amount to achieve the effect of real-time planning. For example, the planning cycle may be set to 1 milliseconds (ms), that is, the motion planning operation is performed once every interval 1 ms. If the real-time requirement for the motion planning of the wheel-foot composite robot is low, the hardware computing power is insufficient, etc., the planning cycle may be set to a large amount. For example, the planning cycle may be set to 5 ms, that is, a motion planning operation is performed once every interval 5 ms, and the setting of the planning cycle is not specifically limited in the present disclosure.

It should be noted that, when the motion planning module 210 performs motion planning based on the planning cycle, if the wheel-foot composite robot obtains a new working task in one planning cycle, the motion planning module 210 performs motion planning based on the new work task and the latest actual state information of the wheel-foot composite robot. If the wheel-foot composite robot is executing a previous work task in a planning cycle, that is, the last work task is not completed, and no new work task is obtained, the motion planning 210 continues to perform motion planning based on the previous work task and the latest actual state information of the wheel-foot composite robot.

In this embodiment of the present disclosure, the target task is a task that the wheel-foot composite robot is about to perform, and the task may be a full-body task or the like, such as stolon advance, grabbing an object, or obstacle avoidance.

In addition, the target task may be any work task input by the user, or may be any work task obtained by the wheel-foot composite robot from the task allocation database, and the manner of obtaining the target task is not limited in the present disclosure.

In embodiments of the present disclosure, the first motion task of the robot body, the second motion task of the two front leg mechanisms, and the third motion task of the two rear rollers may be understood as motion tasks that need to be performed synchronously by different components of the wheel-foot composite robot when the target task is performed.

Based on the structure of the wheel-foot composite robot shown in FIG. 1, the wheel-foot composite robot of the present disclosure can support a wheel type motion module and a wheel-foot composite motion module. Considering that the four motion mechanisms of the wheel-foot composite robot include two rear rollers and two front leg mechanisms, the rear roller is always in a wheel type motion mode, because the tail end of each front leg mechanism is provided with a roller, the front leg mechanism may include two motion modes, specifically a wheel type motion mode and a foot type motion mode.

Correspondingly, the wheel-foot composite motion mode supported by the wheel-foot composite robot may be divided into: a first wheel-foot composite motion mode obtained based on a wheel type motion mode of the two rear rollers, a foot type motion mode of the left front leg mechanism, and a wheel type motion mode of the right front leg mechanism; a second wheel-foot composite motion mode obtained based on the wheel type motion mode of the two rear rollers, the wheel type motion mode of the left front leg mechanism, and the foot type motion mode of the right front leg mechanism; and a third wheel-foot composite motion mode obtained based on the wheel type motion mode of the two rear rollers and the foot type motion modes of the two front leg mechanisms.

In embodiments of the present disclosure, the motion mode of the wheel-foot composite robot is specifically a wheel-foot composite motion mode, and the wheel-foot composite motion mode specifically refers to a third wheel-foot composite motion mode obtained based on the wheel type motion mode of the two rear rollers and the foot type motion modes of the two front leg mechanisms. That is, the rear leg mechanism of the wheel-foot composite robot is in a wheel type motion mode, and the front leg mechanism is in a foot type motion mode.

Because the roller is arranged at the tail end of the front leg mechanism, in order to enable the front leg mechanism to be in the foot type motion mode, the roller in the front leg mechanism can be locked through the motor corresponding to the ankle joint in the front leg mechanism, so that the roller in the front leg mechanism is switched from the wheel type motion mode to the supporting leg in contact with the ground, so that the front leg mechanism can be ensured to be in a foot type motion mode.

In some optional embodiments, the robot body may be understood as a robot torso, the robot torso occupies a certain physical space, and in order to determine the first motion task of the robot torso, the present disclosure may reduce the difficulty of determining the first motion task by determining the first motion task of a center point of the robot torso. That is, the first motion task of the robot body in the present disclosure specifically refers to the first motion task of the center point of the robot body.

When the two front leg mechanisms of the wheel-foot composite robot in the present disclosure are in a foot motion mode, the motions of the left front leg mechanism and the right front leg mechanism are similar to the walking gait of a person. That is, in each motion cycle, one front leg mechanism leaves the ground to be in a lifted state, and the other front leg mechanism contacts the ground to be in a supporting state. The front leg mechanism that leaves the ground in the lifted state may be referred to as a lifted leg mechanism, and the front leg structure that contacts the ground in the supporting state may be referred to as a supporting leg mechanism. Correspondingly, the lifted leg mechanism corresponds to a lifted foot, and the supporting leg mechanism corresponds to the supporting leg.

In some optional embodiments, the walking gait of the two front leg mechanisms of the wheel-foot composite robot may be determined by a preset gait cycle t, a support time t_{stand}, and a support phase tₚₕₐₛₑ. That is, different gait may be generated based on different gait cycles t, support times t_{stand}, and support phases tₚₕₐₛₑ. It should be noted that the gait cycle t, the support time t_{stand}, and the support phase tₚₕₐₛₑ in the present disclosure are both adjustable parameters, which may be flexibly adjusted according to the walking gait planning requirement of the front leg mechanism of the wheel-foot composite robot, which is not limited in the present disclosure.

For example, assuming that the walking gait of the two front leg mechanisms of the wheel-foot composite robot is a cross gait, the gait of the left front leg mechanism in the two front leg mechanisms may be t=1 seconds(s), t_{stand}=0.5 s, and tₚₕₐₛₑ=0%; the gait of the right front leg mechanism may be t=1 seconds (s), t_{stand}=0.5 s, and tₚₕₐₛₑ=50%.

Considering that the supporting foot corresponding to the front leg mechanisms in the supporting state in the two front leg mechanisms is always in contact with the ground and do not slip, the position of the supporting foot is consistent in the world coordinate system and is known, while the touchdown point of the lifted foot, corresponding to the front leg mechanism that is off the ground and is in the lifted state, is unknown. Therefore, in order to ensure that the wheel-foot composite robot maintains the balance of the body during the motion process, it is necessary to control the position of the touchdown point of the lifted foot corresponding to the front leg mechanism that leaves the ground in the lifted state. That is, the second motion task of the two front leg mechanisms is determined in the present disclosure, specifically, the second motion task of the lifted leg mechanism in the two front leg mechanisms is determined.

In some optional embodiments, since the two rear rollers are the driving wheels during the motion of the wheel-foot composite robot, there may be factors such as control error, which causes the rear roller to move too quickly or too slowly, thereby causing the position of the roller of the wheel-foot composite robot to deviate from the preset position, that is, the rear roller rotates. Therefore, in order to enable the motion process of the rear roller to be matched with the normal motion of the wheel-foot composite robot, it is necessary to ensure that the center point of the two rear rollers must always remain directly behind the robot's torso at a specific position, so as to ensure the balance of the entire wheel-foot composite robot. That is, in the present disclosure, determining the third motion task of the two rear rollers specifically refers to determining the third motion task of the center point of the two rear rollers.

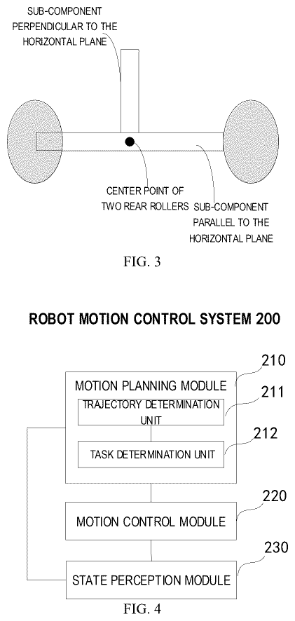

In the present disclosure, the center point of the two rear rollers may be a center point of a connecting member provided with rear rollers at both ends, as shown in FIG. 3.

In some optional embodiments, as shown in FIG. 4, the motion planning module 210 of the present disclosure may include a trajectory determination unit 211 and a task determination unit 212, wherein the trajectory determination unit 211 is configured to determine a whole-body motion trajectory of the wheel-foot composite robot based on the target task; and the task determination unit 212 is configured to determine a first motion task of the robot body, a second motion task of the two front-leg mechanisms, and a third motion task of the two rear rollers based on the whole-body motion trajectory and the first actual state information.

As an optional implementation, the trajectory determination unit 211 may use a preset robot motion trajectory planning method to plan a whole-body motion trajectory of the target task by the wheel-foot composite robot based on the target task. It should be understood that the whole-body motion trajectory is a desired whole-body motion trajectory when the wheel-foot composite robot performs the task to be performed.

In the present disclosure, the whole-body motion trajectory may include a motion trajectory of the robot body, a motion trajectory of the lifted foot corresponding to the lifted leg mechanism, and a motion trajectory of the center point of two rear rollers; wherein the motion trajectory of the robot body includes an expect motion parameter for determining the first motion task of the robot body, such as expected position information, expected posture information, and expected velocity information, etc. Similarly, the motion trajectory of the lifted foot corresponding to the lifted leg mechanism includes an expected motion parameter for determining the second motion task of the lifted leg mechanism in the two front leg mechanisms. In addition, the motion trajectory of the center point of the two rear rollers includes the expected motion parameter for determining the third motion task of the center point of the two rear rollers.

It should be noted that, when the motion trajectory of the center point of the two rear rollers is planned, in order to maintain the balance of the entire wheel-foot composite robot, the position of the center point of the two rear rollers needs to be controlled to always be at a fixed distance behind the robot body (that is, the robot torso). The posture of the center point of the two rear rollers is determined based on the terrain, the roll angle and the pitch angle are determined based on the terrain, the roll angle and the pitch angle are set to 0 on the flat ground, the yaw angle is kept consistent with the yaw angle of the robot body, and the planning purpose of the motion trajectory of the center point of the two rear rollers is achieved.

The position of the center point of the two rear rollers is located at a fixed distance behind the robot's torso, and this parameter may be determined according to actual debugging of the physical structure of the wheel-foot composite robot.

As an optional implementation, in the present disclosure, a motion trajectory of a center point of the two rear rollers may be planned specifically by obtaining an expected position, an expected posture, an expected velocity, and an expected angular velocity of the robot body. Next, according to a forward Kinematics (FK) algorithm, an expected position, an expected posture, an expected velocity, and an expected angular velocity of the center point of the two rear rollers in the robot body coordinate system are obtained. Then, according to the conversion relationship between the robot body coordinate system and the world coordinate system, the expected position, the expected posture, the expected velocity, and the expected angular velocity of the center point of the two rear rollers in the robot body coordinate system are converted into the expected position, the expected posture, the expected velocity and the expected angular velocity of the center point of the two rear rollers in the world coordinate system, to obtain the motion trajectory of the center point of the two rear rollers. The conversion relationship between the robot body coordinate system and the world coordinate system is known information.

It should be noted that the posture information and the angular velocity information of the center point of the two rear rollers in the present disclosure are specifically the posture information and the angular velocity information of the connecting rods where the center point of the two rear rollers is located.

After the trajectory determination unit 211 determines the whole-body motion trajectory of the wheel-foot composite robot for executing the target task, the task determination unit 212 of the present disclosure may obtain, from the whole-body motion trajectory, the motion parameters required for determining the first motion task, the second motion task, and the third motion task, respectively. Then, the first motion task, the second motion task, and the third motion task are determined based on the obtained motion parameters and the latest actual state information of the wheel-foot composite robot by using the PD control law, respectively. The latest actual state information of the wheel-foot composite robot includes actual motion parameters required for determining the first motion task of the robot body, the second motion task of the lifted leg mechanism in the two front leg mechanisms, and the third motion task of the center point of the two rear rollers, such as actual position information, actual posture information, and actual velocity information.

The PD control law may be understood as a PD control algorithm. It should be understood that the PD control algorithm is a simplified form of the PID control algorithm, mainly adjusting the system output value and the output change rate, so that the system operates stably. Compared with a PID control algorithm, the PD control algorithm is simpler and easy to implement.

Generally, the PD control algorithm includes two parts, the first part is a proportional part, and the second part is a differential part. The proportional part obtains a first output signal by calculating the difference between the current error and the set value and multiplies the difference by a proportional system Kp. The differential part obtains a second output signal by multiplying a derivative coefficient Kd based on the change rate between the current error and the previous error. Then, the first output signal and the second output signal are added to obtain a final output signal.

After the first motion task of the robot body, the second motion task of the two front leg mechanisms, and the third motion task of the two rear rollers are determined, the motion planning module 210 may send the first motion task, the second motion task, and the third motion task to the motion control module 220, so that the motion control module 220 performs whole-body motion control on the wheel-foot composite robot based on the first motion task, the second motion task, and the third motion task, so that the wheel-foot composite robot can efficiently, stably and accurately perform the target task.

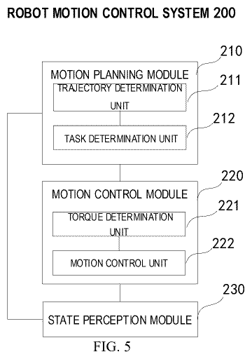

In some optional embodiments, considering that each joint in each motion mechanism of the wheel-foot composite robot in the present disclosure is correspondingly provided with a motor, such as a hip joint provided with a hip joint motor, a knee joint provided with a knee joint motor, and an ankle joint provided with an ankle joint motor. Therefore, the motion control module 220 of the present disclosure may include a torque determination unit 221 and a motion control unit 222, as shown in FIG. 5. The torque determination unit 221 is configured to determine a target torque of each joint in each motion mechanism based on the first motion task, the second motion task, and the third motion task; and the motion control unit 222 is configured to control the whole-body motion of the wheel-foot composite robot based on the target torque of each joint in each motion mechanism.

That is, the motion control module 220 controls the whole-body motion of the wheel-foot composite robot according to the first motion task, the second motion task, and the third motion task, specifically, determines the target torque of each joint in each motion mechanism based on the first motion task, the second motion task, and the third motion task. Then, the whole-body motion of the wheel-foot composite robot is controlled based on the target torque of each joint in each motion mechanism.

In the present disclosure, the torque determination unit 221 determines the target torque of each joint in each motion mechanism based on the first motion task, the second motion task, and the third motion task, and may process the first motion task, the second motion task, and the third motion task into a quadratic programming form, to solve the first motion task, the second motion task, and the third motion task in the quadratic programming form by using the convex optimization algorithm, to obtain the target torque of each joint in each motion mechanism.

That is, the present disclosure converts the whole-body motion control problem of the wheel-foot composite robot into a standard convex optimization problem, and solves the standard convex optimization problem to obtain a global optimal solution, and uses the global optimal solution as the target torque of each joint in each motion mechanism.

In some optional embodiments, the above standard convex optimization problem may be as shown in the following formula (1):

$$\{ \begin{matrix}arg m {i}_{x} n ‖ x ‖ \\ s . t . \dot{v} = J \ddot{q} + \dot{J} \dot{q} \\ C + G = [ - H , {S}^{T} , {J}^{T} ] [ \begin{matrix}\ddot{q} \\ τ \\ F\end{matrix} ] \\ x = [ \begin{matrix}\ddot{q} \\ τ \\ F\end{matrix} ] \\ DF \leq {f}^{μ} \\ lower \leq x \leq upper\end{matrix} \qquad ( 1 )$$

where x is an optimization variable and ∥x∥ s a cost function;

$$\{ \begin{matrix}s . t . \dot{v} = J \ddot{q} + \dot{J} \dot{q} \\ C + G = [ - H , {S}^{T} , {J}^{T} ] [ \begin{matrix}\ddot{q} \\ τ \\ F\end{matrix} ] \\ x = [ \begin{matrix}\ddot{q} \\ τ \\ F\end{matrix} ] \\ DF \leq {f}^{μ} \\ lower \leq x \leq upper \\ \end{matrix}$$

is a constraint set, wherein \dot{v}=J\dot{q}+\dot{J}\dot{q} is constraints for
each motion task constraint;

$$C + G = [ - H , {S}^{T} , {J}^{T} ] [ \begin{matrix}\ddot{q} \\ τ \\ F\end{matrix} ]$$

is a dynamic constraint; DF≤f^{u} is a friction cone constraint;

$$x = [ \begin{matrix}\ddot{q} \\ τ \\ F\end{matrix} ]$$

is a control variable; lower≤x≤supper is a control variable boundary constraint, wherein lower and upper are adjustable parameters, and can be dynamically set based on the hardware of the robot, wherein the upper limit value and the lower limit value of the parameter τ in x are the maximum torque of the joint motor.

The above

$$C + G = [ - H , {S}^{T} , {J}^{T} ] [ \begin{matrix}\ddot{q} \\ τ \\ F\end{matrix} ]$$

is obtained by transforming the robot dynamics equation:

$$H ( q ) \ddot{q} + C ( q , \dot{q} ) \dot{q} + G ( q ) = {S}^{T} τ + {\sum }_{i = 1}^{{N}_{C}} {J}_{i}^{T} {f}_{i} .$$

The meanings of the parameters in the above robot dynamics equation are as follows:
N is the degree of freedom of the robot, the degree of freedom in the present disclosure is an adjustable parameter, and the example may be selected as 18 dimensions, wherein 6 dimensions are for the robot torso and 12 dimensions for the joints, and the present disclosure has no limitation on the degree of freedom of the wheel-foot composite robot;
q∈R^{N} is a generalized position of a robot, and R^{N} represents an N-dimensional variable on a real set;
\dot{q}∈R^{N} is a generalized velocity of a robot;
\ddot{q}∈R^{N-6} is a generalized acceleration of a robot;
τ∈N^{N-6} is the joint driving torque of a robot;
fᵢ ∈R³ is a ground force of the i-th contact point in the world coordinate system;
H∈R^{N×N} is a mass matrix of a robot, which can be rapidly computed using the Composite Rigid Body Algorithm (CRBA);
C∈R^{N×N} represents the centrifugal force and the Coriolis force of a robot, which is rapidly computed by using a Recursive Newton Euler Algorithm (RNEA);
G∈R^{N} is the gravity bias term of a robot, which is rapidly computed by the Recursive Newton Euler Algorithm RNEA;
S∈R^{(N-6)×N} is the selection matrix for distinguishing between the actuated joint and the unactuated joint, denoted as S=diag (0, 0, 0, 0, 0, 0, a1, a2, . . . , an), where aᵢ=0 indicates unactuated joints; the first six elements are set to 0 for unactuated joints;

Jᵢ∈R^{3×y} is the Jacobian matrix of the i-th contact point. It should be noted that because the i-th contact point only considers the Jacobian matrix of the position, and the actual Jacobian matrix is the 6×N dimension, there are only 3×N dimensions here because the position is only considered.

The above friction cone constraint DF≤f^{μ} may be obtained by the following formula:

$$\{ \begin{matrix}{f}_{x} \leq {f}_{z} {f}^{μ} \\ {f}_{y} \leq {f}_{z} {f}^{μ}\end{matrix} ,$$

wherein fₓ is the friction component of the contact point in the X-axis direction in the local coordinate system, f_{y} is the friction component of the contact point in the Y-axis direction in the local coordinate system, and f_{z} is the friction component of the contact point in the Z-axis direction in the local coordinate system, f^{μ} is the friction coefficient. It should be understood that the friction force between each contact point and the ground in the present disclosure is three dimensions, which are, fₓ, f_{y} and f_{z} respectively.

In the present disclosure, the local coordinate system may be understood as a coordinate system of the local ground when the wheel-foot composite robot is in contact with the ground on any local ground. For example, assuming that the wheel-foot composite robot is in contact with the ground on a certain inclined plane, the coordinate system of the inclined plane is the local coordinate system.

Considering that when the wheel-foot composite robot moves to any local ground, the local ground may be a known ground, or the ground may also be obtained by using a perception algorithm based on environmental information collected by the environmental perception sensor, so after

$$\{ \begin{matrix}{f}_{x} \leq {f}_{z} {f}^{μ} \\ {f}_{y} \leq {f}_{z} {f}^{μ}\end{matrix}$$

is obtained in the local coordinate system,

$$\{ \begin{matrix}{f}_{x} \leq {f}_{z} {f}^{μ} \\ {f}_{y} \leq {f}_{z} {f}^{μ}\end{matrix}$$

may be transformed from the local coordinate system to the world coordinate system to obtain the friction cone matrix D in the friction cone constraint. In addition, F in the friction cone constraint may be flexibly set based on the mass of the wheel-foot composite robot, which is not limited in the present disclosure.

In the present disclosure, in each of the above motion task constraints v≐J\ddot{q}+\dot{J}\dot{q}, J is a Jacobian matrix representing a contact point, and q represents a generalized position, [⋅] represents the first derivative, that is, a velocity \dot{q} may be obtained based on the generalized position q, [⋅⋅] represents the second derivative, that is, an acceleration \ddot{q} may be obtained based on the generalized position 1. A relationship between a control variable that needs to be optimized and a motion task corresponding to the wheel-foot compound robot may be established through Jacobian, so that the solution of the optimization problem may help the wheel-foot composite robot complete a corresponding full-body tasks.

Considering that the control variable in the present disclosure is in the joint space, while the first motion task, the second motion task, and the third motion task corresponding to the wheel-foot composite robot are all within a three-dimensional space (that is, a Cartesian space), in order to obtain the constraint \dot{v}=J\ddot{q}+\dot{J}\dot{q} of each motion task, the present disclosure may establish the relationship between the joint space and the three-dimensional space (that is, the Cartesian space) by using the following formula (2):

$$J \dot{q} = v \qquad ( 2 )$$

Then, derivation is performed on the formula (2), and the motion task constraint \dot{v}=J\ddot{q}+\dot{J}\dot{q} corresponding to each motion task may be obtained. In the motion task constraint \dot{v}=J\ddot{q}+\dot{J}\dot{q}, \dot{v} is the acceleration of the center point of the robot body corresponding to the first motion task in the Cartesian coordinate system, the acceleration of the lifted foot of the lifted leg mechanism corresponding to the second motion task in the Cartesian coordinate system, or the acceleration of the center point of the two rear rollers in the Cartesian coordinate system corresponding to the third motion task, J is the Jacobian matrix of each of the motion tasks, and \ddot{q} is the corresponding joint acceleration for realizing each of the motion tasks and \dot{q} is the current joint velocity. The constraint of \ddot{q} may be set based on the maximum acceleration of the robot, which is not specifically limited in the present disclosure.

In some optional embodiments, before determining the target torque of each joint in each motion mechanism in the wheel-foot composite robot based on the foregoing formula (1), optionally, the present disclosure may first compute a Jacobian matrix of the first motion task, a Jacobian matrix of the second motion task, and a Jacobian matrix of the third motion task corresponding to each timestamp. Then, the Jacobian matrix of the first motion task, the Jacobian matrix of the second motion task, and the Jacobian matrix of the third motion task corresponding to the same timestamp are brought into the foregoing motion task constraints \dot{v}=J\ddot{q}+\dot{J}\dot{q} to obtain the corresponding three motion task constraints at the same timestamp.

$$\{ \begin{matrix}{J}_{1} \ddot{q} + {\dot{J}}_{1} \dot{q} = {\dot{v}}_{1} \\ {J}_{2} \ddot{q} + {\dot{J}}_{2} \dot{q} = {\dot{v}}_{2} \\ {J}_{3} \ddot{q} + {\dot{J}}_{3} \dot{q} = {\dot{v}}_{3}\end{matrix} \qquad ( 3 )$$

wherein J₁\ddot{q}+\dot{J}₁\dot{q}=\dot{v}₁ is the first motion task constraint, J₂\ddot{q}+\dot{J}₂\dot{q}=\dot{v}₂ is a second motion task constraint, and J₃\ddot{q}+\dot{J}\dot{q}=\hat{v}₃ is a third motion task constraint.

In the present disclosure, the Jacobian matrix of the first motion task, the Jacobian matrix of the second motion task, and the Jacobian matrix of the third motion task corresponding to each timestamp may be computed, and reference may be made to the prior art, and details are not described herein again.

Then, the three motion task constraints corresponding to different timestamps described in the foregoing formula (3) are brought into the foregoing formula (1) to solve the target torque of each joint of the wheel-foot composite robot at different timestamps.

In the present disclosure, the joints of the wheel-foot composite robot may include: a left hip joint, a left knee joint, and a left ankle joint in a left front leg mechanism, a right hip joint, a right knee joint, and a right ankle joint in a right front leg mechanism, and a back leg hip joint, a back leg knee joint, and a back leg ankle joint in a back leg mechanism, which may be specifically referred to FIG. 1.

It should be noted that the Jacobian matrix of the first motion task is specifically the Jacobian matrix of the center point of the robot body, the Jacobian matrix of the second motion task is specifically the Jacobian matrix corresponding to the lifted foot of the lifted leg mechanism in the front leg mechanism, and the Jacobian matrix of the third motion task is specifically the Jacobian matrix of the center point of the two rear rollers.

In addition, the Jacobian matrices of the first motion task and the third motion task are optional matrices of 6*18 dimensions. Wherein, 6 is 6 degrees of freedom, specifically 3 rotational dimensions and 3 translational dimensions along the X-axis, the Y-axis, and the Z-axis. 18 is the freedom degree of the wheel-foot composite robot. Because the second task is the foot contact point, only the 3-dimensional position is considered, that is, the Jacobian matrix of the second motion task is a 3*18-dimensional matrix, where 3 is 3 degrees of freedom, specifically 3 translational dimensions along the X-axis, the Y-axis, and the Z-axis.

In addition, each motion task may be three-dimensional or six-dimensional. The motion task includes a first motion task, a second motion task, and a third motion task.

The above three dimensions may be understood as three degrees of freedom, specifically three rotation dimensions or 3 translation dimensions along the X axis, the Y axis, and the Z axis, and the six dimensions may be understood as six degrees of freedom, specifically 3 rotation dimensions and 3 translation dimensions along the X axis, the Y axis, and the Z axis.

After the target torque of each joint in each motion mechanism is determined, the whole body motion of the wheel-foot composite robot can be controlled by the motion control unit 222 based on the target torque of each joint in each motion mechanism.

Because each joint of the wheel-foot composite robot corresponds to one motor, after the target torque of each joint in each motion mechanism in the wheel-foot composite robot is obtained, in the present disclosure each motor can be controlled to output a target torque to the corresponding joint based on the target torque of each joint, so as to drive each joint to rotate by a corresponding angle, so that other joints and related mechanisms associated with each joint generate a certain amount of motion in the space, thereby realizing whole-body motion control of the wheel-foot composite robot.

In embodiments of the present disclosure, when the motion control module 220 controls the whole body motion of the wheel-foot composite robot, whole-body motion control may be performed on the wheel-foot composite robot according to a preset control cycle. The control cycle of the motion control module 220 may be comprehensively determined based on factors such as a motion control requirement, a hardware computing power, and an algorithm complexity of the wheel-foot composite robot. In some optional implementations, if the real-time requirement for the motion control of the wheel-foot composite robot is high and the hardware computing power is strong, the control cycle may be set to a small amount to achieve the effect of real-time control. For example, the control cycle may be set to 1 milliseconds (ms), that is, the motion control operation is performed once every interval 1 ms. If the real-time requirement for the motion control of the wheel-foot composite robot is low, the hardware computing power is insufficient, etc., the control cycle may be set to be large. For example, the control cycle may be set to 5 ms, that is, a motion control operation is performed once every interval 5 ms, which is not specifically limited in the present disclosure.

It should be noted that, when the motion control module 220 performs motion control according to the control cycle, if the first motion task, the second motion task, and/or the third motion task sent by the motion planning module 210 are the first motion task, the second motion task, and/or the third motion task of the previous control cycle, the motion control module 220 continues to perform whole-body motion control on the wheel-foot composite robot based on the same first motion task, the second motion task, and/or the third motion task. If the motion planning module 210 sends the new first motion task, the new second motion task, and/or the new third motion task, the motion control module 220 performs whole-body motion control on the wheel-foot composite robot based on the new first motion task, the new second motion task, and/or the new third motion task.

It should be noted that, as long as the wheel-foot composite robot is in the working state, the actual state information of the wheel-foot composite robot can be determined through the state perception module 230, and the actual state information of the wheel-foot composite robot is sent to the motion planning module 210, so that the motion planning module 210 can select the actual state information of the required wheel-foot composite robot to perform the motion planning operation based on the planning requirement.

In the present disclosure, the wheel-foot composite robot further includes an inertial sensor, a foot odometer, and a wheel odometer. Optionally, the inertial sensor, the foot odometer and the wheel odometer may be disposed in the robot body 11, which is not limited in the present disclosure. Therefore, the state perception module 230 may determine the actual state information of the wheel-foot composite robot based on the inertial sensor, the foot odometer, and the wheel odometer.

The inertial sensor may be an inertial measurement unit (IMU) or a device including a component such as an accelerometer and a gyroscope, which is not limited in the present disclosure.

The foot odometer and the wheel odometer belong to two different types of odometers, and are used for measuring and estimating information such as pose and speed of a wheel-foot composite robot. The rotation information or sensor measurement data of the wheels is typically used to compute the displacement and direction changes of the wheel-foot composite robot. Moreover, by continuously accumulating and updating the motion information, an estimation of the pose and speed of the wheel-foot composite robot relative to the starting position may be provided.

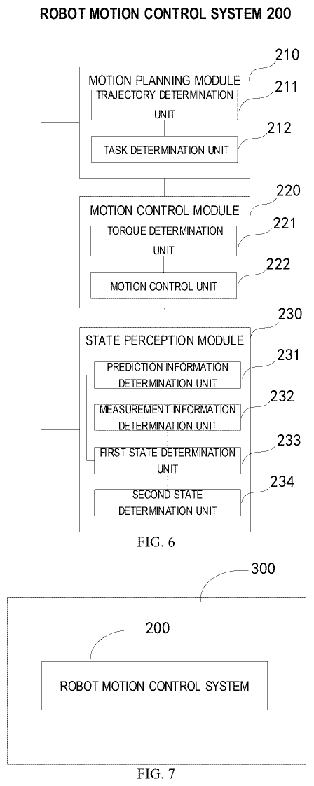

Referring to FIG. 6, the state perception module 230 in the present disclosure may include: a prediction information determination unit 231, a measurement information determination unit 232, a first state determination unit 233, and a second state determination unit 234.

The prediction information determination unit 231 is configured to collect inertial data through an inertial sensor, and determine predicted state information of the robot body based on the inertial data;

The measurement information determination unit 232 is configured to determine measurement state information of the robot body based on the foot odometer and the wheel odometer;

The first state determination unit 233 is configured to determine actual state information of the robot body based on the measurement state information and the predicted state information;

The second state determination unit 234 is configured to determine, based on the actual state information of the robot body, actual state information of the lifted foot corresponding to the lifted leg mechanism in the two front leg mechanisms and actual state information of the center point of the two rear rollers, and obtain the actual state information of the wheel-foot composite robot based on the actual state information of the robot body, the actual state information of the lifted foot, and the actual state information of the center point of the two rear rollers.

In the present disclosure, the above prediction state information refers to a priori prediction state information of the wheel-foot composite robot body. The measurement state information refers to information obtained by performing state measurement on the wheel-foot composite robot body.

Considering that the inertial sensor can collect the inertial data of the wheel-foot composite robot body in real time, the present disclosure can collect the inertial data in each perception cycle through the inertial sensor by the inertial sensor, and determine the measurement state information of the wheel-foot composite robot body based on the collected inertial data. The inertial data includes acceleration and angular velocity.

As an optional implementation, in the present disclosure, the prediction information determination unit 231 may specifically process the inertial data collected by the inertial sensor based on the state transition parameter to obtain the predicted state information of the body of the wheel-foot composite robot in the current perception cycle, which may be specifically shown in the following formula (4):

$${\check{x}}_{k} = {F}_{k - 1} {\hat{x}}_{k - 1} + {B}_{k - 1} {ω}_{k} \qquad ( 4 )$$

wherein x̌ₖ is priori prediction state information of the wheel-foot composite robot body in the current perception cycle k; Fₖ₋₁ is the state transition parameter which is used for describing the posterior actual state information of the wheel-foot composite robot body in the previous perception cycle k−1, to predict the prior prediction state of the current perception cycle k, and the state transition parameter is specifically the state transfer matrix; \hat{x}ₖ₋₁ is the posterior actual state information of the wheel-foot composite robot body in the previous perception cycle k−1; Bₖ₋₁ is the control matrix determined based on the external force which can be understood as the input state transfer parameter, and is used for describing the conversion relationship between the environmental noise and the state information input under the external force; and ωₖ is the inertial data collected by the inertial sensor in the current perception cycle k. In the present disclosure, Bₖ₋₁ may be determined in the prior art, which is not limited in the present disclosure.

It should be understood that the above prediction state information may include: position information, posture information, and velocity information. The velocity information includes a linear velocity and an angular velocity.

Considering that the foot odometer and the wheel odometer may obtain the joint angle data from the joint encoder corresponding to the respective joint of the wheel-foot composite robot, the measurement information determination unit 232 of the present disclosure may specifically determine the first measurement state information of the wheel-foot composite robot body in the current perception cycle k based on the joint angle data of the wheel-foot composite robot acquired from the joint encoder of the respective joint in the current perception cycle k by using the foot odometer, and determine the second measurement state information of the wheel-foot composite robot body in the current perception cycle k based on the joint angle data of the wheel-foot composite robot acquired from the joint encoder of the corresponding joint in the current perception cycle k by using the wheel odometer.

In the present disclosure, the measurement state information may include: position information, posture information, and velocity information. The velocity information includes a linear velocity and an angular velocity.

In some optional embodiments, considering that each joint in each front leg mechanism corresponds to a joint encoder, and each joint encoder stores angle data of a corresponding joint. Moreover, the supporting foot corresponding to the supporting leg mechanism in the supporting state in contact with the ground is assumed to be unchanged on the ground. Therefore, the measurement information determination unit 232 of the present disclosure determines the first measurement state information of the wheel-foot composite robot body in the current perception cycle k based on the joint angle data of the wheel-foot composite robot acquired from the joint encoder of the corresponding joint by using the foot odometer, and the specific process is as follows:

First, the first joint angle data of the wheel-foot composite robot in the current perception cycle k is obtained from the joint encoder corresponding to each joint in the supporting leg mechanism through the foot odometer. The amount of the first joint angle data is multiple, specifically, the hip joint angle data, the knee joint angle data, and the ankle joint angle data. Then, the first measurement state information of the wheel-foot composite robot body in the current perception cycle k is determined based on the plurality of pieces of first joint angle data.

In some optional embodiments, the joint angle data stored in the joint encoder may be understood as joint positions. Therefore, in the present disclosure, determining the first measurement state information of the wheel-foot composite robot body in the current perception cycle k based on the plurality of pieces of first joint angle data may be, optionally, by performing differential operation on each first joint angle data to obtain the actual speed (that is, the joint speed) of each first joint. Then, based on the joint position and the joint velocity of each joint in the supporting leg mechanism, the motion velocity of the wheel-foot composite robot body relative to the supporting foot corresponding to the supporting leg mechanism is computed.

In addition, ankle joint angle data is obtained from the plurality of pieces of first joint angle data, and then pose information of the wheel-foot composite robot body relative to the supporting foot corresponding to the supporting leg mechanism in current perception cycle k is computed based on the ankle joint angle data by using an FK algorithm. The pose information includes position information and posture information.

In the present disclosure, the implementation process of computing to obtain, based on the joint position and the joint speed of each joint in the supporting leg mechanism, the motion velocity of the wheel-foot composite robot body relative to the supporting foot corresponding to the supporting leg mechanism in the current perception cycle k is: computing a Jacobian matrix based on joint positions of all joints in the supporting leg mechanism, and then computing a product of the Jacobian matrix and the joint speed of each joint, to obtain the motion velocity of the supporting foot corresponding to the supporting leg mechanism relative to the wheel-foot composite robot body. Further, the motion velocity of the supporting leg corresponding to the supporting leg mechanism relative to the wheel-foot composite robot body is multiplied by −1 to obtain the motion velocity of the wheel-foot composite robot body relative to the supporting leg corresponding to the supporting leg mechanism in current perception cycle k.

Optionally, computing the motion velocity of the wheel-foot composite robot body relative to the supporting leg corresponding to the supporting leg mechanism in the current perception cycle k may be implemented by the following formula (5):

$$( {J}_{k} \cdot {\dot{q}}_{k} ) * - 1 = {v}_{k} \qquad ( 5 )$$

wherein Jₖ is the Jacobian matrix computed according to the joint positions of all joints in the supporting leg mechanism in the support state in the current perception cycle k, \dot{q}ₖ is the joint speed of each joint in the supporting leg mechanism in the support state for the current perception cycle k, and vₖ is the motion velocity of the wheel-foot composite robot body relative to the supporting foot corresponding to the supporting leg mechanism in the current perception cycle k.

In addition, in the present disclosure, the pose information of the wheel-foot composite robot body relative to the supporting foot corresponding to the supporting leg mechanism in the current perception cycle k is computed based on the ankle joint angle data by using the FK algorithm, and may be implemented by using the following formula (6):

$${}^{body} {P}_{foot} = FK ( q ) \qquad ( 6 )$$

wherein ^{body}P_{foot} is the pose information of the wheel-foot composite robot body corresponding to the supporting foot corresponding to the supporting leg mechanism in the current perception cycle k, FK ( ) is a positive kinematics algorithm, and q is ankle joint angle data.

Considering that the conversion relationship between the supporting foot coordinate system and the world coordinate system is known or can be computed by using a conversion algorithm, after obtaining the measurement state information (position information, posture information, and velocity information) of the wheel-foot composite robot body relative to the supporting foot corresponding to the supporting leg mechanism, the measurement state information of the wheel-foot composite robot body relative to the supporting foot can be converted into the measurement state information of the wheel-foot composite robot body relative to the world coordinate system based on the conversion relationship between the supporting foot coordinate system and the world coordinate system, so as to obtain the first measurement state information of the wheel-foot composite robot body in the world coordinate system.

In some optional embodiments, the rear leg mechanism of the wheel-foot composite robot includes two rear rollers, a rear thigh mechanism shared by the two rear rollers, a rear shank mechanism, and a connecting member provided with two rear rollers. For the rear roller of the wheel-foot composite robot, since the rear roller is always on the ground, and it is assumed that there is a pure rolling between the rear roller and the ground, the measurement information determination unit 232 of the present disclosure may acquire the second joint angle data corresponding to each rear roller in the current perception cycle k from the joint encoder corresponding to each rear roller through the wheel odometer. In addition, the radius of each rear roller is also obtained from the configuration information of the wheel-foot composite robot. Further, the second measurement state information of the wheel-foot composite robot body in the current perception cycle k is determined based on the second joint angle data corresponding to each rear roller and the radius of each rear roller.

The second joint angle data corresponding to the first rear roller and the second rear roller may have a plurality of pieces of second joint angle data, and specifically, the second joint angle data corresponding to the second rear roller includes: hip joint angle data, knee joint angle data and ankle joint angle data corresponding to the first rear roller; and the second joint angle data corresponding to the second rear roller includes: hip joint angle data, knee joint angle data, and ankle joint angle data corresponding to the second rear roller.

In some optional embodiments, the determining, based on the second joint angle data corresponding to each rear roller and the radius of each rear roller, second measurement state information of the wheel-foot composite robot body in the current perception cycle k may be implemented in the following formula (7):

$${D}_{m} = {q}_{m} \times {r}_{m} \qquad ( 7 )$$

wherein Dₘ is the rolling distance of the m-th rear roller on the ground in the current perception cycle k, qₘ is the second joint angle data corresponding to the m-th rear roller in the current perception cycle k, and rₘ is the radius of the m-th rear roller, wherein m∈[1,2].

Because the two rear rollers are constrained by the differential wheel system, the moving distance of the center point of the two rear rollers on the ground is computed based on the rolling distance of each rear roller on the ground. Further, the moving speed of the center point of the two rear rollers relative to the wheel-foot composite robot body is computed based on the moving distance between the center point of the two rear rollers actually on the ground and the difference between the previous perception cycle k and the current perception cycle k. Then, the motion velocity of the center point of the two rear rollers relative to the wheel-foot composite robot body is multiplied by −1, to obtain the motion velocity of the wheel-foot composite robot body relative to the center point of the two rear rollers.

In addition, the present disclosure may further compute the pose information of the wheel-foot composite robot body relative to the center point of the two rear rollers in the current perception cycle k based on the actual moving distance of the center point of the two rear rollers on the ground by using the FK algorithm.

Considering that the conversion relationship between the coordinate system (local coordinate system) corresponding to the center point of the two rear rollers and the world coordinate system is known or can be calculated by using a conversion algorithm, after obtaining the measurement state information of the wheel-foot composite robot body relative to the center point of the two rear rollers, the measurement state information of the wheel-foot composite robot body relative to the center point of the two rear rollers can be converted into the measurement state information of the wheel-foot composite robot body relative to the world coordinate system based on the conversion relationship between the local coordinate system and the world coordinate system, so as to obtain the second measurement state information of the wheel-foot composite robot body in the world coordinate system.

After the predicted state information and the measurement state information (the first measurement state information and the second measurement state information) are obtained, the first state determination unit 233 may first process the posterior estimation covariance of the wheel-foot composite robot body in the previous perception cycle k−1 by using the state transition parameter, the control matrix, and the state transition noise corresponding to the wheel-foot composite robot, to obtain a priori estimated covariance of the wheel-foot composite robot body in the current perception cycle k. Then, the prior estimated covariance of the current perception cycle k is processed based on the observation matrix, the observation noise covariance matrix and the observed noise variance amount, to obtain the filtering gain of the current perception cycle k. Further, an extended Kalman filter (EKF) algorithm is used to perform fusion processing on the measurement state information and the prediction state information of the wheel-foot composite robot body in the current perception cycle k based on the filtering gain and the observation matrix of the current perception cycle k, to obtain the actual state information of the wheel-foot composite robot body in the current perception cycle k.

In an optional implementation, the processing the posterior estimation covariance of the wheel-foot composite robot body in the previous perception cycle k−1 by using the state transition parameter, the control matrix and the state transition noise corresponding to the wheel-foot composite robot to obtain a priori estimated covariance of the wheel-foot composite robot body in the current perception cycle k may be implemented by the following formula (8):

$${\check{P}}_{k} = {F}_{k - 1} {\hat{P}}_{k - 1} {F}_{k - 1}^{T} + {B}_{k - 1} {Q}_{k} {B}_{k - 1}^{T} \qquad ( 8 )$$

Wherein Pₖ is the prior estimated covariance of the wheel-foot composite robot body in the current perception cycle k, Fₖ₋₁ is the state transition parameter of the previous perception cycle k−1, \hat{P}ₖ₋₁ is the posterior estimation covariance of the previous perception cycle k−1, Fₖ₋₁^{r} is the transpose of the state transition parameter of the previous perception cycle k−1, Bₖ₋₁ is the control matrix determined based on the external force which can be understood as the input state transition parameter used to describe the conversion relationship between the environmental noise and the state information input under the external force, and Qₖ is the uncertainty of the motion environment corresponding to the current perception cycle k, and Bₖ₋₁^{r} is the transposition of the control matrix.

In addition, processing the prior estimation covariance of the wheel-foot composite robot body in the current perception cycle k, based on the observation matrix, the observation noise covariance matrix, and the observation noise variance amount, to obtain the filtering gain of the current perception cycle k, which may be implemented by the following formula (9):

$${K}_{k} = {\check{P}}_{k} {{G}_{k}^{T} ( {G}_{k} {\check{P}}_{k} {G}_{k}^{T} + {C}_{k} {R}_{k} {C}_{k}^{T} )}^{- 1} \qquad ( 9 )$$

wherein Kₖ is the filtering gain for the current perception cycle k, P̌ₖ is a priori estimated covariance of the wheel-foot composite robot body in the current perception cycle k, Gₖ is an observation matrix of the current perception cycle k which is used to map the state matrix to the observation space and describes a relationship between state variable and the observation variable, G_{z}^{T} is a transposition of the observation matrix Gₖ, Cₖ is an observation noise covariance matrix of the current perception cycle k for describing a statistical characteristic of the observation noise and including a variance and a covariance of the observation error, Cₖ^{T} is a transposition of the observation noise covariance matrix Cₖ, and Rₖ is an observation noise variance amount.

In addition, using the EKF algorithm, based on the filtering gain and the observation matrix of the current perception cycle k, perform fusion processing on the measurement state information and the prediction state information of the wheel-foot composite robot body in the current perception cycle k to obtain the actual state information of the wheel-foot composite robot body in the current perception cycle k, which may be implemented by the following formula (10):

$${\hat{x}}_{k} = {\check{x}}_{k} + {K}_{k} ( {y}_{k} - {G}_{k} {\check{x}}_{k} ) \qquad ( 10 )$$

wherein \hat{x}ₖ is the actual state information of the wheel-foot composite robot body in the current perception cycle k, x̌ₖ is the prior prediction state information of the wheel-foot composite robot body in the current perception cycle k, Kₖ is the filtering gain of the current perception cycle k, yₖ is the measurement state information of the wheel-foot composite robot body in the current perception cycle k, the measurement state information in the present disclosure includes the first measurement state determined by the foot odometer and the second measurement state determined by the wheel odometer, and Gₖ is the observation matrix of the current perception cycle k.

That is, in the present disclosure, the actual state information of the wheel-foot composite robot body in the current perception cycle k is obtained by fusing the measurement state information and the prediction state information of the wheel-foot composite robot body in the current perception cycle k.

In the present disclosure, the actual state information may include: position information, posture information, and velocity information. The velocity information includes a linear velocity and an angular velocity.

In some optional embodiments, when the second state determination unit 234 in the present disclosure determines the actual state information of the wheel-foot composite robot, the following steps may be included:

Step 1: based on the actual state information of the robot body, the actual state information of the lifted foot relative to the robot body and the actual state information of the center point of the two rear rollers relative to the robot body are respectively computed by using a forward Kinematics (FK) algorithm.

Step 2, according to the transformation relationship between the robot body coordinate system and the world coordinate system, the actual state information of the lifted foot relative to the robot body is converted into the actual state information of the lifted foot in the world coordinate system, and the actual state information of the center point of the two rear rollers relative to the robot body is converted into the actual state information of the center point of the two rear rollers in the world coordinate system.

The conversion relationship between the robot body coordinate system and the world coordinate system is known.

In the present disclosure, the actual position information of the robot body includes: actual position information, actual posture information, actual velocity information, and actual angular velocity information; the actual state information of the lifted foot corresponding to the lifted leg mechanism in the two front leg mechanisms includes actual position information and actual velocity information; and the actual state information of the center point of the two rear rollers includes: actual position information, actual posture information, actual velocity information, and actual angular velocity information.

After obtaining the actual state information of the lifted foot corresponding to the lifted leg mechanism in the two front leg mechanisms and the actual state information of the center point of the two rear rollers, the second state determination unit 234 may determine the actual state information of the robot body, the actual state information of the lifted foot corresponding to the lifted leg mechanism in the two front leg mechanisms, and the actual state information of the center point of the two rear rollers as the actual state information of the wheel-foot composite robot, and send the actual state information of the wheel-foot composite robot to the motion planning module 210, so that the motion planning module 210 performs the motion planning of the next planning cycle on the wheel-foot composite robot based on the actual state information of the wheel-foot composite robot sensed by the state perception module 230.

In this embodiment of the present disclosure, when the state perception module 230 determines the actual state information of the wheel-foot composite robot, the actual state information of the wheel-foot composite robot may be determined based on a preset perception cycle. The perception cycle of the state perception module 230 may be comprehensively determined based on factors such as a state perception requirement, a hardware computing power, and an algorithm complexity of the wheel-foot composite robot. In some optional implementations, if the real-time requirement for the actual state perception of the wheel-foot composite robot is high, the hardware computing power is strong, and the like, the perception cycle may be set to a small amount to achieve a real-time perception effect. For example, the perception cycle may be set to 0.5 milliseconds (ms), that is, a state perception operation is performed once every 0.5 ms. If the real-time requirement for the actual state perception of the wheel-foot composite robot is low, the hardware computing power is weak, etc., the perception cycle may be set to be large. For example, the perception cycle may be set to 5 ms, that is, a state perception operation is performed once every interval 5 ms, which is not specifically limited in the present disclosure.

It should be noted that, the state perception module 230 determining the actual state information of the wheel-foot composite robot is irrelevant to whether the wheel-foot composite robot executes the working task, that is, when the wheel-foot composite robot is in the working state, the actual state operation of the wheel-foot composite robot is determined, as long as the perception cycle is reached, regardless of whether the wheel-foot composite robot executes the working task.

Based on the technical scheme disclosed by embodiments of the invention, the first motion task of the robot body, the second motion task of the two front leg mechanisms and the third motion task of the two rear rollers are determined through the motion planning module based on the target task and the latest actual state information of the wheel-foot composite robot, then the whole body motion of the wheel-foot composite robot is controlled through the motion control module based on the first motion task, the second motion task and the third motion task output by the motion planning module, then the actual state information of the wheel-foot composite robot is determined through the state perception module, and the actual state information of the wheel-foot composite robot is sent to the motion planning module, so that the motion planning module performs new motion planning based on the actual state information of the wheel-foot composite robot. This enables precise closed-loop control of the robot's motion, so that the robot can efficiently, stably and accurately execute the task, thereby improving the robot's task performance and enhancing user experience.

As an optional implementation of the present disclosure, the motion trajectory of the robot body of the wheel-foot composite robot of the present disclosure includes expected position information, expected posture information, expected velocity information, and expected angle information of the robot body. The motion trajectory of the lifted foot corresponding to the lifted leg mechanism of the wheel-foot composite robot comprises the expected position information and the expected velocity information of the lifted foot. The motion trajectory of the center point of two rear rollers of the wheel-foot composite robot includes expected position information, expected posture information, expected velocity information and expected angular velocity information of the center point of the two rear rollers.

In addition, the latest actual state information of the wheel-foot composite robot includes: latest actual position information, latest actual posture information, latest actual velocity information, and latest actual angular velocity information of the robot body; latest actual position information and latest actual velocity information of the lifted foot corresponding to the lifted leg mechanism in the two front leg mechanisms, latest actual position information, latest actual posture information, latest actual velocity information, and latest actual angular velocity of the center point of the two rear rollers.

Therefore, the task determination unit 212 of the present disclosure determines the first motion task of the robot body, the second motion task of the lifted leg mechanism in the two front leg mechanisms, and the motion task of the center point of the two rear rollers, which may include the following parts:

Part one, the determining the first motion task of the robot body may specifically include the following steps:

Step 11: determining a position motion sub-task of the robot body based on the expected position information, the latest actual position information, the expected velocity information, and the latest actual velocity information of the robot body.

Step 12: determining a posture motion sub-task of the robot body based on the expected posture information, the latest actual posture information, the expected angular velocity information, and the latest actual angular velocity information of the robot body.

Step 13: obtaining a first motion task of the robot body based on the position motion sub-task and the posture motion sub-task of the robot body.

It should be understood that the first motion task of the robot body includes: a position motion sub-task and a posture motion sub-task of the robot body.

In an optional implementation, the position motion sub-task of the robot body may be determined by using the following formula (11):

$${\dot{v}}_{body} = {kp}_{p} ( {p}_{des} - {p}_{act} ) + {kd}_{p} ( {v}_{des} - {v}_{act} ) \qquad ( 11 )$$

wherein \dot{v}_{body} is the robot body position motion sub-task, and \dot{v}_{body}∈R³, wherein \dot{v}_{body} corresponds to 4 to 6 dimensions of \ddot{q} in the dynamic equation, p_{des} are the expected position information of the robot body; p_{act} is the latest actual position information of the robot body; v_{des} is the expected velocity information of the robot body; v_{act} is the latest actual velocity information of the robot body; KPₚ is the position control gain of the robot body, kdₚ is the velocity control gain of the robot body, and kpₚ and kdₚ are respectively adjustable parameters.

In addition, the posture motion sub-task of the robot body may be determined by using the following formula (12):

$${\dot{ω}}_{body} = {kp}_{rpy} ( {rpy}_{des} - {rpy}_{act} ) + {kd}_{rpy} ( {ω}_{des} - {ω}_{act} ) \qquad ( 12 )$$

wherein ω_{body} is the robot body posture motion sub-task, and ω_{body}∈R³, wherein \dot{ω}_{body} corresponds to 1 to 3 dimensions of \ddot{q} in the dynamic equation, rpy_{des} is the expected posture information of the robot body, wherein the rpy is specifically an abbreviation of the roll-pitch-yaw; pry_{act} is the latest actual posture information of the robot body, ω_{des} is the expected angular velocity information of the robot body; ω_{act} is the latest actual angular velocity information of the robot body; kp_{rpy} is the posture control gain of the robot body, kd_{rpy} is a velocity control gain of the robot body, and kp_{rpy} and kd_{rpy} are adjustable parameters.

Considering that posture can be represented in multiple ways including quaternion, rotation matrix, and rpy posture angle, as an optional implementation, the present disclosure uses the rpy posture angle to represent the posture. That is, the posture motion sub-task of the robot body is determined based on the posture of the robot body represented by the rpy posture angle. Of course, in the present disclosure, the posture motion sub-task of the robot body may also be determined based on the posture of the robot body represented by the quaternion, or based on the posture of the robot body represented by the rotation matrix, which is not limited herein.

It should be noted that, in the foregoing execution sequence of step 11 and step 12, step 11 may be performed first and then step 12 is performed; or step 12 is performed first and then step 11 is performed; or step 11 and step 12 are performed in parallel, which is not limited in the present disclosure.

Part two, determining the second motion task of the lifted leg mechanism may specifically include the following steps: determining the second motion task of the lifted leg mechanism based on the expected position information, the latest actual position information, the expected velocity information, and the latest actual velocity information of the lifted foot.

In some optional embodiments, the second motion task of the lifted leg mechanism in the two front leg mechanisms may be determined by using the following formula (13):

$${\dot{v}}_{foot} = kp ( {p}_{des} - {p}_{act} ) + kd ( {v}_{des} - {v}_{act} ) \qquad ( 13 )$$

wherein \dot{v}_{foot} is the second motion task of the lifted leg mechanism in the two front leg mechanisms; p_{des} is the expected position information of the lifted foot; p_{act} is the latest actual position information of the lifted foot; v_{des} is the expected velocity of the lifted foot; v_{act} is the latest actual velocity information of the lifted foot; kp is the position control gain of the lifted foot, kd is the velocity control gain of the lifted foot, and kp and kd are adjustable parameters respectively.

It should be noted that, in the present disclosure, the expected position of the lifted foot of the lifted leg mechanism can also be first computed by the motion planning module 210 based on the robot body's latest actual angular velocity information to determine the angle the robot body can rotate during the remaining swing time of the swing leg mechanism. Next, the position information hip_pos_local of the lifted foot corresponding to the lifted leg mechanism in the hip coordinate system corresponding to the lifted leg mechanism is computed. Then, the position transformation of position information hhip_pos_local caused by the robot body's rotation at the end of the swing leg mechanism's swing. Finally, based on the position information of the robot body in the world coordinate system, the position information hhip_pos_local of the lifted foot corresponding to the lifted leg mechanism in the corresponding hip joint coordinate system of the lifted leg mechanism, the translation speed of the robot body relative to the world coordinate system, and the remaining swing time of the lifted foot, the expected position of the lifted foot of the lifted leg mechanism is computed. It should be understood that the expected position of the lifted foot of the lifted leg mechanism refers to an expected position of the lifted foot of the lifted leg mechanism at the moment of landing in the world coordinate system.

Part three, determining the third motion task of the center point of the two rear rollers may specifically include the following steps:

In step 21, determining a position motion sub-task of the center point of the two rear rollers based on the expected position information, the latest actual position information, the expected velocity information and the latest actual velocity information of the center point of the two rear rollers.

In step 22, determining a posture motion sub-task of the center point of the two rear rollers based on the expected posture information, the latest actual posture information, the expected angular velocity information and the latest actual angular velocity information of the center point of the two rear rollers.

Step 23: obtaining a third motion task of the center point of the two rear rollers based on the position motion sub-task and the posture motion sub-task of the center point of the two rear rollers.

It should be understood that the third motion task of the center point of the two rear rollers includes: a position motion sub-task and a posture motion sub-task of the center point of the two rear rollers.

In some optional implementations, determining the position motion sub-task of the center point of the two rear rollers may be implemented by the following formula (14):

$${\dot{v}}_{center} = {kp}_{center} ( {p}_{des} - {p}_{act} ) + {kd}_{center} ( {v}_{des} - {v}_{act} ) \qquad ( 14 )$$

wherein \dot{v}_{center} is the position motion sub-task of the center point of the two rear rollers; p_{des} is the expected position information of the center point of the two rear rollers, p_{act} is the latest actual position information of the center point of the two rear rollers; v_{des} is the expected velocity of the center point of the two rear rollers; v_{act} is the latest actual velocity information of the center point of the two rear rollers; kp_{center} is the position control gain for the center point of the two rear rollers, and kd_{center} is the velocity control gain for the center point of the two rear rollers, and kp_{center} and kd_{center} are respectively adjustable parameters.

In addition, the posture motion sub-tasks of the center point of the two rear rollers may be determined by using the following formula (15):

$${\dot{ω}}_{center} = {kp}_{center} ( {rpy}_{des} - {rpy}_{act} ) + {kd}_{center} ( {ω}_{des} - {ω}_{act} ) \qquad ( 15 )$$

wherein ω̅_{center} is the posture motion sub-task of the center point of the two rear rollers; rpy_{des} is the expected posture information of the center point of the two rear rollers, rpy_{act} is the latest actual posture information of the center point of the center point of the two rear rollers; ω_{des} is the expected angular velocity information of the two rear rollers, ω_{act} is the latest actual angular velocity information of the center point of the two rear rollers; kp_{center} is the posture control gain of the robot body, kd_{center} is a velocity control gain of the robot body, and the kp_{center} and kd_{center} are respectively adjustable parameters.

Considering that posture can be represented in multiple ways including quaternion, rotation matrix, and rpy posture angle, as an optional implementation, the present disclosure uses the rpy posture angle to represent the posture. That is, the posture motion sub-task of the center point of the two rear rollers is determined based on the posture of the center point of the two rear rollers represented by the rpy posture angle. Of course, in the present disclosure, the posture motion sub-task of the center point of the two rear rollers may also be determined based on the posture of the center point of the two rear rollers represented by the quaternion, or based on the posture of the center point of the two rear rollers represented by the rotation matrix, which is not limited herein.

It should be noted that, in the foregoing execution sequence of step 21 and step 22, step 21 may be performed first and then step 22 is performed; or step 22 is performed first and then step 21 is performed; or step 21 and step 22 are performed in parallel, which is not limited in the present disclosure.

The technical solution disclosed in embodiments of the present disclosure can achieve precise closed-loop control of the robot's motion, ensuring efficient, smooth, and precise task execution, thereby improving the robot's task performance and enhancing user experience.

Referring to FIG. 7, the following describes a robot according to embodiments of the present disclosure. In the present disclosure, the robot is the wheel-foot composite robot shown in the aforementioned FIG. 1, which includes a robot body and four motion mechanisms mounted on the robot body, where the four motion mechanisms include two rear rollers and two front leg mechanisms. As shown in FIG. 7, the robot 300 includes the robot motion control system 200 provided in the first aspect according to embodiments of the present disclosure.

Those skilled in the art can recognize that the modules and algorithm steps described in embodiments disclosed herein can be implemented through electronic hardware or a combination of computer software and electronic hardware. Whether these functions are executed by hardware or software depends on the specific application and design constraints of the technical solution. Professional technicians can use different methods to implement the described functions for each specific application, but such implementation should not be considered to exceed the scope of this application.

In several embodiments provided in this application, it should be understood that the disclosed systems, devices, and methods can be implemented in other ways. For example, the above-described device embodiments are merely illustrative. For instance, the division of modules is merely a logical functional division, and there can be other division methods in actual implementation. For example, multiple modules or components can be combined or integrated into another system, or some features can be ignored or not executed. Furthermore, the shown or discussed coupling or direct coupling or communication connection between components can be through some interfaces, devices, or modules' indirect coupling or communication connection, which can be electrical, mechanical, or in other forms.

The modules described as separate components can be or need not be physically separate. The components shown as modules can be or need not be physical modules, meaning they can be located in one place or distributed across multiple network units. Some or all modules can be selected to implement the objectives of this embodiment solution according to actual needs. For example, in various embodiments of this application, the functional modules can be integrated into one processing module, exist physically separate, or two or more modules can be integrated into one module.

In this application's embodiments, the terms “module” or “unit” refer to computer programs or parts of computer programs with predetermined functions that work together with other related parts to achieve predetermined objectives, and can be implemented wholly or partially through software, hardware (such as processing circuits or memory), or their combination. Similarly, one processor (or multiple processors or memory) can be used to implement one or more modules or units. Additionally, each module or unit can be part of an overall module or unit that contains the functionality of that module or unit.

The above description is only specific implementation methods of this application, but the protection scope of this application is not limited to these. Any technical personnel familiar with this field can easily think of changes or substitutions within the technical scope disclosed in this application, which should be covered within the protection scope of this application. Therefore, the protection scope of this application should be based on the protection scope of the claims.

I/We claim:

1. A motion control system of a robot, wherein the robot is a wheel-foot composite robot, the wheel-foot composite robot comprises a robot body and four motion mechanisms arranged on the robot body, the four motion mechanisms comprise two rear rollers and two front leg mechanisms, and the system comprises: a motion planning module, a motion control module and a state perception module;
wherein the motion planning module is configured to determine a first motion task of the robot body, a second motion task of the two front leg mechanisms, and a third motion task of the two rear rollers based on a target task and latest actual state information of the wheel-foot composite robot;
the motion control module is configured to control whole-body motion of the wheel-foot composite robot based on the first motion task, the second motion task, and the third motion task sent by the motion planning module;
the state perception module is configured to determine actual state information of the wheel-foot composite robot, and send the actual state information of the wheel-foot composite robot to the motion planning module, so that the motion planning module performs new motion planning based on the actual state information of the wheel-foot composite robot.

2. The system of claim 1, wherein the motion planning module comprises: a trajectory determination unit and a task determination unit,
wherein the trajectory determination unit is configured to determine a whole-body motion trajectory of the wheel-foot composite robot based on the target task,
the task determination unit is configured to determine the first motion task of the robot body, the second motion task of the two front leg mechanisms, and the third motion task of the two rear rollers based on the whole-body motion trajectory and the latest actual state information.

3. The system of claim 2, wherein a motion mode of the wheel-foot composite robot is a wheel-foot composite motion mode;
correspondingly, the first motion task is a motion task of a center point of the robot body;
the second motion task is a motion task of a lifted leg mechanism in the two front leg mechanisms;
the third motion task is a motion task of a center point of the two rear rollers.

4. The system of claim 3, wherein the whole-body motion trajectory comprises: a motion trajectory of the robot body, a motion trajectory of a lifted foot corresponding to the lifted leg mechanism, and a motion trajectory of the center point of the two rear rollers;
correspondingly, the task determination unit is specifically configured to obtain expected position information, expected posture information, expected velocity information and expected angular velocity information of the robot body based on the motion trajectory of the robot body; obtain expected position information and expected velocity information of the lifted foot based on the motion trajectory of the lifted foot corresponding to the lifted leg mechanism; and obtain expected position information, expected posture information, expected velocity information and expected angular velocity information of the center point of the two rear rollers based on the motion trajectory of the center point of the two rear rollers.

5. The system of claim 4, wherein the latest actual state information comprises: latest actual position information, latest actual posture information, latest actual velocity information and latest actual angular velocity information of the robot body, latest actual position information and latest actual velocity information of the lifted foot corresponding to the lifted leg mechanism in the two front leg mechanisms, and latest actual position information, latest actual posture information, latest actual velocity information, and latest actual angular velocity of the center point of the two rear rollers.

6. The system of claim 5, wherein the task determination unit is further configured to:
determine a position motion sub-task of the robot body based on the expected position information, the latest actual position information, the expected velocity information, and the latest actual velocity information of the robot body; determine a posture motion sub-task of the robot body based on the expected posture information, the latest actual posture information, the expected angular velocity information, and the latest actual angular velocity information of the robot body; and obtain the first motion task of the robot body based on the position motion sub-task and the posture motion sub-task of the robot body.

7. The system of claim 5, wherein the task determination unit is further configured to:
determine the second motion task of the lifted leg mechanism in the two front leg mechanisms based on the expected position information, the latest actual position information, the expected velocity information, and the latest actual velocity information of the lifted foot.

8. The system of claim 5, wherein the task determination unit is further configured to:
determine a position motion sub-task of the center point of the two rear rollers based on the expected position information, the latest actual position information, the expected velocity information and the latest actual velocity information of the center point of the two rear rollers; determine a posture motion sub-task of the center point of the two rear rollers based on the expected posture information, the latest actual posture information, the expected angular velocity information and the latest actual angular velocity information of the center point of the two rear rollers; and obtain the third motion task of the center point of the two rear rollers based on the position motion sub-task and the posture motion sub-task of the center point of the two rear rollers.

9. The system of claim 1, wherein the motion control module comprises: a torque determination unit and a motion control unit,
wherein the torque determination unit is configured to determine a target torque of each joint in each motion mechanism based on the first motion task, the second motion task, and the third motion task;
the motion control unit is configured to control the whole-body motion of the wheel-foot composite robot based on the target torque of each joint in the each motion mechanism.

10. The system of claim 1, wherein the wheel-foot composite robot further comprises an inertial sensor, a foot odometer and a wheel odometer, and the state perception module comprises: a prediction information determination unit, a measurement information determination unit, a first state determination unit, and a second state determination unit,
wherein the prediction information determination unit is configured to collect inertial data through the inertial sensor, and determine predicted state information of the robot body based on the inertial data;
the measurement information determination unit is configured to determine measurement state information of the robot body based on the foot odometer and the wheel odometer, respectively;
the first state determination unit is configured to determine actual state information of the robot body based on the measurement state information and the prediction state information;
the second state determination unit is configured to determine, based on the actual state information of the robot body, actual state information of the lifted foot corresponding to the lifted leg mechanism in the two front leg mechanisms and actual state information of the center point of the two rear rollers, and obtain the actual state information of the wheel-foot composite robot based on the actual state information of the robot body, the actual state information of the lifted foot, and the actual state information of the center point of the two rear rollers.

11. A robot, wherein the robot is a wheel-foot composite robot and comprises:
a robot body and four motion mechanisms arranged on the robot body, the four motion mechanisms comprising two rear rollers and two front leg mechanisms; and
a motion control system comprising a motion planning module, a motion control module and a state perception module,
wherein the motion planning module is configured to determine a first motion task of the robot body, a second motion task of the two front leg mechanisms, and a third motion task of the two rear rollers based on a target task and latest actual state information of the wheel-foot composite robot;
the motion control module is configured to control whole-body motion of the wheel-foot composite robot based on the first motion task, the second motion task, and the third motion task sent by the motion planning module;
the state perception module is configured to determine actual state information of the wheel-foot composite robot, and send the actual state information of the wheel-foot composite robot to the motion planning module, so that the motion planning module performs new motion planning based on the actual state information of the wheel-foot composite robot.

12. The robot of claim 11, wherein the motion planning module comprises: a trajectory determination unit and a task determination unit,
wherein the trajectory determination unit is configured to determine a whole-body motion trajectory of the wheel-foot composite robot based on the target task,
the task determination unit is configured to determine the first motion task of the robot body, the second motion task of the two front leg mechanisms, and the third motion task of the two rear rollers based on the whole-body motion trajectory and the latest actual state information.

13. The robot of claim 12, wherein a motion mode of the wheel-foot composite robot is a wheel-foot composite motion mode;
correspondingly, the first motion task is a motion task of a center point of the robot body;
the second motion task is a motion task of a lifted leg mechanism in the two front leg mechanisms;
the third motion task is a motion task of a center point of the two rear rollers.

14. The robot of claim 13, wherein the whole-body motion trajectory comprises: a motion trajectory of the robot body, a motion trajectory of a lifted foot corresponding to the lifted leg mechanism, and a motion trajectory of the center point of the two rear rollers;
correspondingly, the task determination unit is specifically configured to obtain expected position information, expected posture information, expected velocity information and expected angular velocity information of the robot body based on the motion trajectory of the robot body; obtain expected position information and expected velocity information of the lifted foot based on the motion trajectory of the lifted foot corresponding to the lifted leg mechanism; and obtain expected position information, expected posture information, expected velocity information and expected angular velocity information of the center point of the two rear rollers based on the motion trajectory of the center point of the two rear rollers.

15. The robot of claim 14, wherein the latest actual state information comprises: latest actual position information, latest actual posture information, latest actual velocity information and latest actual angular velocity information of the robot body, latest actual position information and latest actual velocity information of the lifted foot corresponding to the lifted leg mechanism in the two front leg mechanisms, and latest actual position information, latest actual posture information, latest actual velocity information, and latest actual angular velocity of the center point of the two rear rollers.

16. The robot of claim 15, wherein the task determination unit is further configured to:
determine a position motion sub-task of the robot body based on the expected position information, the latest actual position information, the expected velocity information, and the latest actual velocity information of the robot body; determine a posture motion sub-task of the robot body based on the expected posture information, the latest actual posture information, the expected angular velocity information, and the latest actual angular velocity information of the robot body; and obtain the first motion task of the robot body based on the position motion sub-task and the posture motion sub-task of the robot body.

17. The robot of claim 15, wherein the task determination unit is further configured to:
determine the second motion task of the lifted leg mechanism in the two front leg mechanisms based on the expected position information, the latest actual position information, the expected velocity information, and the latest actual velocity information of the lifted foot.

18. The robot of claim 15, wherein the task determination unit is further configured to:
determine a position motion sub-task of the center point of the two rear rollers based on the expected position information, the latest actual position information, the expected velocity information and the latest actual velocity information of the center point of the two rear rollers; determine a posture motion sub-task of the center point of the two rear rollers based on the expected posture information, the latest actual posture information, the expected angular velocity information and the latest actual angular velocity information of the center point of the two rear rollers; and obtain the third motion task of the center point of the two rear rollers based on the position motion sub-task and the posture motion sub-task of the center point of the two rear rollers.

19. The robot of claim 11, wherein the motion control module comprises: a torque determination unit and a motion control unit,
wherein the torque determination unit is configured to determine a target torque of each joint in each motion mechanism based on the first motion task, the second motion task, and the third motion task;
the motion control unit is configured to control the whole-body motion of the wheel-foot composite robot based on the target torque of each joint in the each motion mechanism.

20. The robot of claim 11, wherein the wheel-foot composite robot further comprises an inertial sensor, a foot odometer and a wheel odometer, and the state perception module comprises: a prediction information determination unit, a measurement information determination unit, a first state determination unit, and a second state determination unit,
wherein the prediction information determination unit is configured to collect inertial data through the inertial sensor, and determine predicted state information of the robot body based on the inertial data;
the measurement information determination unit is configured to determine measurement state information of the robot body based on the foot odometer and the wheel odometer, respectively;
the first state determination unit is configured to determine actual state information of the robot body based on the measurement state information and the prediction state information;
the second state determination unit is configured to determine, based on the actual state information of the robot body, actual state information of the lifted foot corresponding to the lifted leg mechanism in the two front leg mechanisms and actual state information of the center point of the two rear rollers, and obtain the actual state information of the wheel-foot composite robot based on the actual state information of the robot body, the actual state information of the lifted foot, and the actual state information of the center point of the two rear rollers.
